(19) United States
(12) Patent Application Publication
(10) Pub. No.: US 2019/0317020 A1
(43) Pub. Date: Oct. 17, 2019

(54) Micro-screening Apparatus, Process, and Products

(71) Applicant: The Board of Trustees of the Leland Stanford Junior University, Palo Alto, CA (US)

(72) Inventors: Thomas M. Baer, Mountain View, CA (US); Spencer Caleb Alford, Mountain View, CA (US)

(21) Appl. No.: 16/471,934

(22) PCT Filed: Dec. 20, 2017
(86) PCT No.: PCT/US2017/067539

§ 371 Date: Jun. 20, 2019

Related U.S. Application Data
(60) Provisional application No. 62/436,850, filed on Dec. 20, 2016.

(51) Int. Cl. G01N 21/64

(52) U.S. Cl. CPC G01N 21/6452; G01N 2021/6421; G01N 2021/6478; G01N 21/6458

(57) ABSTRACT

An example system includes an excitation light source and one or more optical elements to focus the excitation light onto cavities of an array. One or more samples disposed in the cavities emits a respective fluorescence signal in response to the excitation light. A grating causes each fluorescence signal to diffract. The diffraction produces a zero order beam and a first order beam for each fluorescence signal. A camera captures an image of the zero order beam and the first order beam from an image relay lens, which causes the first order beam to be spatially separated from the zero order beam on the image. The image indicates an intensity profile based on the spatial separation. The intensity profile identifies the at least one sample.

### RELATED APPLICATION

This application claims the benefit of U.S. Provisional Application Ser. No. 62/436,850, filed Dec. 20, 2016, which is incorporated herein by reference in its entirety.

### BACKGROUND

### Field

The disclosure is directed to the determination of compounds of interest using micropore arrays.

### Background

High-throughput measurements have begun to provide insight into the intrinsic complexities and dense interconnectivities of biological systems. As examples, whole-genome sequencing has yielded a wealth of information on crucial genes and mutations underlying disease pathophysiology, DNA microarrays have allowed transcription patterns of various cancers to be dissected, and large-scale proteomics methods have facilitated the study of signaling networks in cells responding to various growth factors. However, the ability to rapidly interrogate the sequence-structure-activity relationship of millions of protein variants, with functional read-outs that span a range of biophysical and biochemical measurements, remains a critical unmet need in high-throughput biology.

Protein engineers rely heavily on directed evolution, a powerful combinatorial screening method which uses selective pressure to evolve proteins with improved properties. Using this approach, libraries are screened to identify proteins with desirable characteristics, such as high affinity binding to a target of interest, stability, expression, or enzymatic activity. Maintaining a genotype-to-phenotype linkage is a fundamental requirement for any directed evolution effort; a protein variant must remain associated with its corresponding DNA sequence to be identified following a screen. This requirement is most easily achieved in assays used to screen for protein binding partners. As examples, genetic fusion of protein variants to microbial cell surface or phage components or translation machinery has allowed rapid identification of target binders from large protein libraries (10⁷-10¹⁴ variants) using fluorescence-activated cell sorting (FACS) or panning methods.

Protein analysis methods that employ spatial segregation, such as testing individual enzyme variants in microtiter plates, have expanded protein engineering applications beyond binding interactions, but are generally limited in throughput to 10³-10⁵ variants in a typical screen. These relatively small library sizes are restrictive due to the vast theoretical diversity of amino acid search space for a typical protein. Robotic handling systems for assaying protein function in microtiter plates have eased labor, but are still relatively low-throughput (e.g. 100,000 assays per day), and require cost-prohibitive quantities of materials and reagents. Recently, oil-water emulsion droplets created in bulk or combined with microfluidics chips have achieved success in high-throughput enzyme engineering applications, however, this technology can be challenging to implement and does not easily allow temporal measurements of kinetic parameters in real-time during an experiment.

### SUMMARY

According to embodiments of the present disclosure, an example system for analyzing one or more samples disposed in cavities of an array includes an excitation light source configured to emit an excitation light having one or more excitation wavelengths that cause one or more samples disposed in respective cavities of an array to fluoresce. The example system includes a cylinder lens configured to transmit the excitation light from the excitation light source as an astigmatic beam. The example system includes a microscope objective configured to receive the astigmatic beam from the cylinder lens and to focus the excitation light as a line onto a column of cavities of the array. One or more samples disposed in the column of cavities simultaneously emit a respective fluorescence signal in response to the line of excitation light. The microscope objective is further configured to transmit each respective fluorescence signal simultaneously. The example system includes a grating configured to receive each respective fluorescence signal simultaneously and cause each respective fluorescence signal from the microscope objective to diffract. The diffraction produces a zero order beam and a first order beam for each respective fluorescence signal. The example system includes an image relay lens configured to receive the zero order beam and the first order beam for each respective fluorescence signal from the grating. The example system includes a camera configured to capture an image of the zero order beam and the first order beam from the image relay lens for each respective fluorescence signal. The image relay lens causes the first order beam to be spatially separated from the zero order beam on the image. The image indicates an intensity profile based on the spatial separation between the first order beam and the zero order beam. The intensity profile identifies the at least one sample.

According to embodiments of the present disclosure, another example system for analyzing one or more samples disposed in cavities of an array includes an excitation light source configured to emit an excitation light having one or more excitation wavelengths that cause one or more samples disposed in respective cavities of an array to fluoresce. The example system includes one or more optical elements configured to receive and focus the excitation light onto cavities of the array. The example system includes a grating configured to receive a respective fluorescence signal emitted from each of the one or more samples in response to the excitation light, and to cause each respective fluorescence signal to diffract. The diffraction produces a zero order beam and a first order beam for each respective fluorescence signal. The example system includes an image relay lens configured to receive the zero order beam and the first order beam for each respective fluorescence signal from the grating. The example system includes a camera configured to capture an image of the zero order beam and the first order beam from the image relay lens for each respective fluorescence signal. The image relay lens causes the first order beam to be spatially separated from the zero order beam on the image. The image indicates an intensity profile based on a plurality of intensities across a spectrum of a plurality of fluorescence wavelengths based on the spatial separation between the first order beam and the zero order beam. The intensity profile identifies the at least one sample.

### BRIEF DESCRIPTION OF THE FIGURES

FIG. 1 illustrates an example system that provides high-throughput multispectral analysis of samples in a micropore array, according to aspects of the present disclosure.

FIG. 2 illustrates an example image of a zero order beam and a first order beam captured for each of four samples providing fluorescence signals in response to an excitation light, according to aspects of the present disclosure.

FIG. 3 illustrates an example graph of the linear relationship between wavelength and an offset as measured by pixel number from a zero order beam for fluorescence signals captured according to aspects of the present disclosure.

FIG. 4A illustrates an example image of first order beams captured for each of two samples providing fluorescence signals in response to an excitation light, according to aspects of the present disclosure

FIG. 4B illustrates an example wavelength intensity profile for the fluorescence signal from each of the two samples of FIG. 4A.

FIG. 5 and FIG. 6 illustrate an example process of extraction of the contents from cavities of cavity arrays using a laser focused on, and delivering electromagnetic radiation to, the interface between the sample and the wall of the cavity.

### DESCRIPTION

In various embodiments, the disclosure is directed to the screening of large populations of biological elements for the presence or absence of subpopulation of biological elements or a single element. The embodiments of the disclosure can be used to discover, characterize and select specific interactions from a heterogeneous population of millions or billions of biological elements.

In one aspect, the disclosure is directed to the identification of properties of engineered fluorescent proteins (FPs) according to specific excitation/emission wavelengths, long Stoke's shifts, single emission peaks, and/or narrow excitation/emission peaks. Unfortunately, screening libraries of fluorescent protein variants for those exhibiting desired traits has been largely limited to time consuming (days) and low-to-medium throughput screening. Typically, the spectra of small-scale protein isolates are collected using plate-readers and microtiter plates. Variants exhibiting desired properties (e.g., red-shifted emission wavelengths) are selected for propagation and isolation.

With embodiments of the disclosure, rapid screening of variants greatly enhances the ability to spectrally tune fluorescent proteins with highly optimized properties (e.g., the properties mentioned above, pH sensitivity, photoswitching, photoconversion, photoactivation, spectral orthogonality for multiparameter imaging, etc.).

Embodiments of the disclosure allow directed evolution of fluorescent proteins. This may address the disconnect between fluorescent protein behavior in prokaryotes versus eukaryotes (i.e., good FPs in bacteria do not always behave well in mammalian cells). The ability to image cells in micropores also permits the direct selection of FPs with favorable properties, such as lack of aggregation, good performance as fusion proteins, and good expression in specific cell types (e.g. neurons). The phenotype-genotype link is preserved in such applications.

Other related applications include engineering enhanced enzymes using ratiometric fluorescent substrates or pH sensitive dyes, internalization assays for protein-based therapeutics/drug conjugates

In one example, the disclosure relates to a multi-purpose technology platform, also sometimes referred to as a Micropore Array Protein Engineering Platform, that is capable of analyzing dense arrays of spatially segregated single clones or their products. Target cells are isolated post analysis using a precise but gentle laser-based extraction technique. Embodiments of the disclosure can provide rapid, high-throughput imaging of fluorescence signals from samples in dense micropore arrays to enable functional analysis of millions of cell-produced protein variants within a time frame of minutes.

### Definitions

Unless otherwise defined, the technical and scientific terms used herein have the same meaning as commonly understood by one of ordinary skill in the art. Expansion and clarification of some terms are provided herein. All publications, patent applications, patents and other references mentioned herein, if not otherwise indicated, are explicitly incorporated by reference.

As used herein, the singular forms “a,” “an”, and “the” include plural referents unless the context clearly dictates otherwise.

The terms “binding partner”, “ligand” or “receptor” as used herein, may be any of a large number of different molecules, or aggregates, and the terms are used interchangeably. In various embodiments, the binding partner may be associated with or bind an analyte being detected. Proteins, polypeptides, peptides, nucleic acids (nucleotides, oligonucleotides and polynucleotides), antibodies, saccharides, polysaccharides, lipids, receptors, test compounds (particularly those produced by combinatorial chemistry), may each be a binding partner.

The term “biological cell” or “cell” refers to any cell from an organism, including, but not limited to, insect, microbial, fungal (for example, yeast) or animal, (for example, mammalian) cells. A biological cell may also host and optionally, display, a virus of interest or a virus having a genotype of interest.

The term “biological element” as used herein, refers to any biological cell or bioreactive molecule. Non-limiting examples of the bioreactive molecules include proteins, nucleic acids, peptides, antibodies, antibody fragments, enzymes, hormones, and small molecules.

An “analyte” generally refers to an element of interest in a sample, for example a biological element of interest in a biological sample.

The term “bind” or “attach” as used herein, includes any physical attachment or close association, which may be permanent or temporary. Non-limiting examples of these associations are hydrogen bonding, hydrophobic forces, van der Waals forces, covalent bonding, and/or ionic bonding. These interactions can facilitate physical attachment between a molecule of interest and the analyte being measured. The “binding” interaction may be brief as in the situation where binding causes a chemical reaction to occur, such as for example when the binding component is an enzyme and the analyte is a substrate for the enzyme.

Specific binding reactions resulting from contact between the binding agent and the analyte are also within this definition. Such reactions are the result of interaction of, for example, an antibody and, for example a protein or peptide, such that the interaction is dependent upon the presence of a particular structure (e.g., an antigenic determinant or epitope) on a protein. Specific binding interactions can occur between other molecules as well, including, for example, protein-protein interactions, protein-small molecule interactions, antibody-small molecule interactions, and protein-carbohydrate interactions. Each of these interactions may occur at the surface of a cell.

The term “sample” as used herein is used in its broadest sense and includes environmental and biological samples. Environmental samples include material from the environment such as soil and water. Biological samples may be animal, including, human, fluid (e.g., blood, plasma, serum, urine, saliva), solid (e.g., stool), tissue, liquid foods (e.g., milk), and solid foods (e.g., vegetables). For example, a pulmonary sample may be collected by bronchoalveolar lavage (BAL), which comprises fluid and cells derived from lung tissues. Other examples of biological samples may comprise a cell, tissue extract, body fluid, chromosomes or extrachromosomal elements isolated from a cell, genomic DNA, RNA, cDNA and the like.

Example Multispectral Analysis System for Samples in a Micropore Arrays

Turning now to the various aspects of the disclosure, the arrays of the disclosure include reaction cavities (or microcavities) or pores included in an extreme density porous array. As further described herein, micropore arrays contemplated herein can be manufactured by bundling millions or billions of cavities or pores.

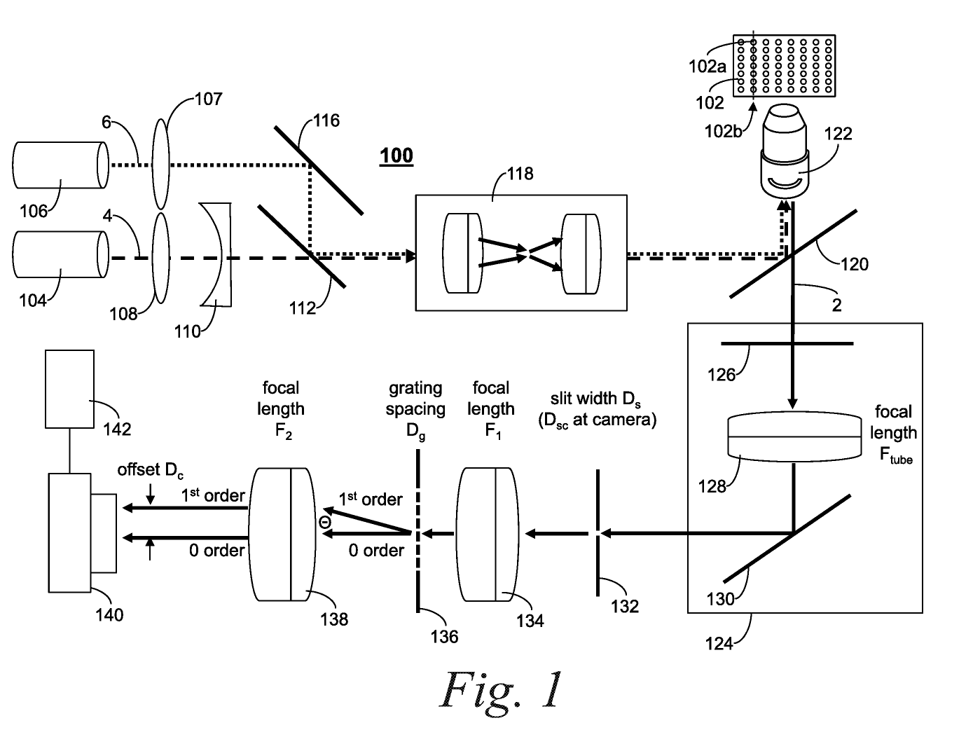

FIG. 1 illustrates an example system 100 that can provide high-throughput multispectral analysis of samples in a dense micropore array 102. Embodiments of the example system 100 can analyze millions of samples in a few hours. The micropore array 102 includes a plurality of cavities 102a arranged in columns 102b. Each cavity 102a is configured to receive a sample that can be analyzed according to fluorescence emission by the sample. For instance, the sample may include a label detectable according to a fluorescent moiety as described below.

The system 100 can scan the micropore array 102 column-by-column and simultaneously measure fluorescence signals 2 from respective samples along a given column 102b. In an example embodiment, each column 102b may include thirty cavities 102a and the system 100 can simultaneously measure the fluorescence signals 2 from the thirty cavities 102a in a given column 102b. Furthermore, the system 100 may scan fifty columns 102b per second. The system 100 can thus take measurements from 1500 cavities per second for high-throughput analysis. In other embodiments, each column 102b may include a different number of cavities 102a and the system 100 may scan the columns 102b at a different rate. For instance, each column 102b may include up to several hundred cavities 102a to provide greater throughput.

As shown in FIG. 1, the system 100 includes an excitation laser source 104 that emits an excitation laser 4. The excitation laser source 104, for instance, may be a laser diode. The system 100 delivers the excitation laser 4 to the micropore array 102 to cause the samples in the cavities 102a to emit respective fluorescence signals 2. The excitation laser 4 may have any combination of wavelengths appropriate to trigger the emission of the fluorescence signals 2.

The system 100 also includes an electromagnetic radiation source 106 that provides electromagnetic radiation that can extract selected samples from individual cavities 102a according to the extraction techniques described below. As shown in FIG. 1, the electromagnetic radiation source 106 may include a laser diode that provides an extraction laser 6. The system 100 includes a collimating lens 107 to collimate the extraction laser 6 from the electromagnetic radiation source 106. Based on an analysis of the fluorescence signals 2 detected by the system 100 with the excitation laser 4, selected cavities 102a with desired properties can be identified and their contents can be extracted with the extraction laser 6 for further characterization and expansion. Although the system 100 as shown in FIG. 1 includes the electromagnetic radiation source 106, the ability to extract samples, e.g., with the extraction laser 6, may be optionally omitted from other embodiments.

The excitation laser source 104 and the electromagnetic radiation source 106 may include high-power (e.g., approximately 200 mW) semiconductor laser diodes. For instance, the excitation laser source 104 may include an Osram model PLTS 450 nm laser diode (OSRAM Opto Semiconductors GmbH, Germany), while the electromagnetic radiation source 106 may include a Sharp model GH0632IA2G 638 nm laser diode (Sharp Corporation, Japan).

The system 100 includes a collimating lens 108, a cylinder lens 110, and a first dichroic beamsplitter 112. In an example embodiment, for instance, the collimating lens 108 may have a short focal length of approximately 10 mm while the cylinder lens 110 may have a focal length of approximately 75 mm. The excitation laser 4 from the source 104 is collimated by the collimating lens 108 and the resulting collimated beam is directed through the cylinder lens 110. The collimated beam, for instance, may have a diameter of approximately 5 mm at the cylinder lens 110. The cylinder lens 110 produces an astigmatic beam which is directed to the first dichroic beamsplitter 112. In particular, the cylinder lens 110 converts the collimated beam to a beam with an angular divergence in only one dimension, while the other dimension remains collimated.

The extraction laser 6 is also directed to the first dichroic beamsplitter 112 via one or more mirrors 116. The first dichroic beamsplitter 112 allows the wavelengths of the excitation laser 4 to pass through its body, but reflects the wavelengths of the extraction laser 6. As such, the first dichroic beamsplitter 112 can transmit the excitation laser 4 and the extraction laser 6 along a common path by allowing the excitation laser 4 to continue on a path but reflecting the extraction laser 6 onto the same path.

The system 100 includes an image relay telescope 118, a second dichroic beamsplitter 120, and a microscope objective 122. The micropore array 102 is disposed at the focal plane of the microscope objective 122. The image relay telescope 118 transfers an image of the entrance pupil of the microscope objective 122 to a plane near the first dichroic beamsplitter 112 to facilitate alignment of the excitation laser 4 and the extraction laser 6 with respect to the microscope objective 122.

The second dichroic beamsplitter 120 reflects the wavelengths of the excitation laser 4 and the extraction laser 6. As such, the combined excitation laser 4 and extraction laser 6 are directed to the second dichroic beamsplitter 120 and reflected to the microscope objective 122. The microscope objective 122 causes the astigmatic beam of the excitation laser 4 to be focused to a line at the micropore array 102. In particular, the image relay telescope 118 reimages the astigmatic beam at the entrance of the objective lens 122. The collimated dimension of the astigmatic beam is focused to a small dimension (e.g., a few microns) by the objective lens 122 at the objective lens focal plane, while the other (diverging) dimension of the astigmatic beam is not focused, resulting in a line of excitation light in the focal plane of the objective lens 122. This line of excitation light can be positioned over a particular column 102b to cause the samples in the corresponding cavities 102a to fluoresce.

The system 100 can scan the line of excitation light over the columns 102b of the micropore array 102 to cause all samples in the micropore array 102 to fluoresce. For instance, an electromechanical device may be employed to change the position of the micropore array 102 relative to the microscope objective 120 and allow the line of excitation light to move over the micropore array 102 along an axis transverse to the columns 102b.

Meanwhile, the extraction laser 6 is focused to a point at the micropore array 102. This point of extraction light can be positioned over a particular cavity 102a to extract a selected sample. For instance, the electromechanical device may also be employed to change the position of the micropore array 102 relative to the microscope objective 120 and allow the point of extraction light to move over the micropore array 102 along axes parallel and transverse to the columns 102b.

When the excitation laser 4 causes the samples in a particular column 102b to fluoresce, the resulting fluorescence signals 2 are directed back through the microscope objective 122 and to the second dichroic beamsplitter 120. Although the second dichroic beamsplitter 120 may reflect the wavelengths of the excitation laser 4 and the extraction laser 6, the second dichroic beamsplitter 120 allows the wavelengths of the fluorescence signals 2 to pass through its body to additional elements for processing the fluorescence signals 2 as described further below.

In alternative embodiments, rather than employing the second dichroic beamsplitter 120, the system 100 may include a partially reflective mirror that directs portions of the excitation laser 4 and the extraction laser 6 to the micropore array 102 while transmitting a portion of the fluorescent signals 2 from the micropore array 102 for further processing. The reflectivity of the partially reflective mirror can be chosen to optimize the fluorescence signal and extraction efficiency. A reasonable compromise, for instance, may be a broadband reflectivity of 50%.

In other embodiments, rather than employing the second dichroic beamsplitter 120, the system 100 may include a polarizer. The excitation laser 4 and the extraction laser 6 may be polarized so that the polarizer reflects the excitation laser 4 and the extraction laser 6 to the micropore array 102. Meanwhile, the fluorescent signals 2 from the micropore array 102 are unpolarized, and as such, can pass through the polarizer with an efficiency of approximately 50%.

The system 100 includes a filter 126, a tube lens 128 with a focal length F_{tube}, and one or more mirrors 130, all of which may be assembled in a microscope body 124. The filter 126 transmits the fluorescence signals 2 for further analysis, while blocking any other light, for instance from the excitation laser 4 and the extraction light 6, which may create unwanted signal noise. For example, the filter 126 may be a long pass filter that allows longer wavelengths the fluorescence signals 2 to be transmitted while blocking the shorter wavelengths of the excitation laser 4 and the extraction light 6.

The system 100 also includes a slit 132 with a width Dₛ a first image relay lens 134 with a focal length F₁, a grating 136 with groove spacing D_{g}, a second image relay lens 138 with a focal length F₂, and a camera 140 which may be a charge coupled device (CCD) camera. The tube lens 128 receives the fluorescence signals 2 from the filter 126 and images the fluorescence signals 2 onto the slit 132 via the one or more mirrors 130. The slit 132 passes a line image of the fluorescence signals 2 from the samples to the first image relay lens 134. In particular, the slit 132 is located in the focal plane of the first image relay lens 134. From the line image, the first image relay lens 134 produces a collimated beam containing the fluorescence signal 2 for each of the samples from the column 102b.

The collimated beams from the first image relay lens 134 pass through the grating 136. The groove spacing D_{g} for the grating 136 is determined according to the desired wavelength dispersion of the fluorescence signals 2. For instance, the groove spacing D_{g} may be approximately 100 lines/mm, 200 lines/mm, or 300 lines/mm. The grating 136 diffracts the beam for each sample and produces a first order beam. A zero order beam remains undiffracted while the first order beam is angled away. For each sample, the first order beam is determined by the wavelengths of the fluorescence signal 2 which are each directed along a respective angle θ from the zero order beam as described further below.

The grating 136 is disposed between the first image relay lens 134 and the second image relay lens 138.

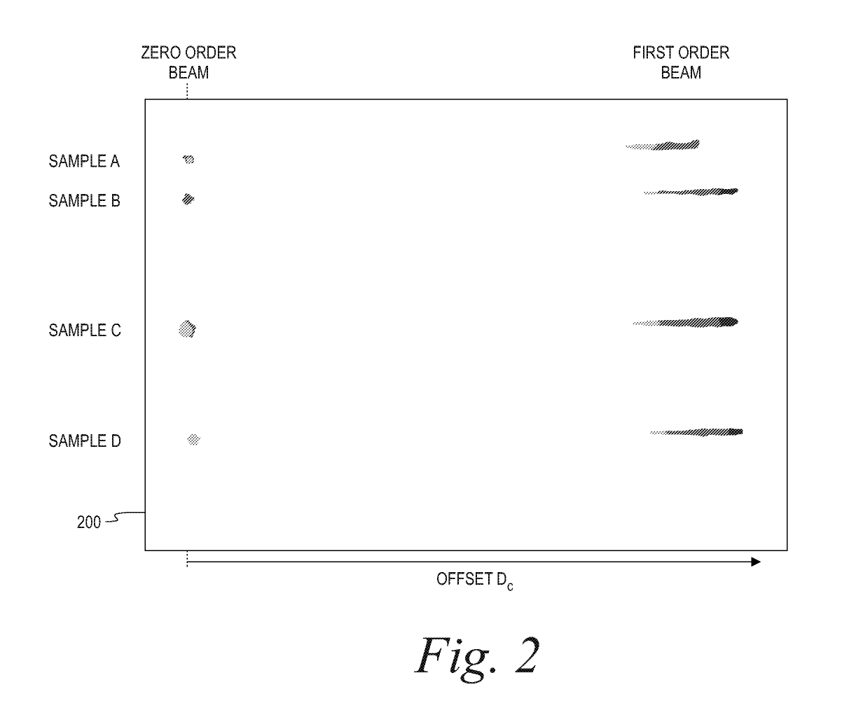

For each sample, the second image relay lens 138 images the zero order beam and the first order beam onto the camera 140. In other words, the first image relay lens 134 focuses the image from the slit 132 at infinity and the second image relay lens 138 refocuses the image from the grating 136 on the camera 140. FIG. 2 illustrates an example image 200 of the zero order beam and the first order beam captured by the camera 140 for each of four samples A-D. (For high-throughput, a greater number of samples are included.) The vertical arrangement of the samples A-D corresponds to the scanned column 102a, while the corresponding horizontal image includes the zero order beam and the first order beam produced by the grating 136 for the respective sample. At the image plane of the camera 140, the first order beam for each sample is spatially separated from the zero order beam according to an offset D_{c} for each wavelength in the fluorescence signal 2.

The following equations provide the relationship between each wavelength λ of the fluorescence signal 2, the width D_{sc} of the slit 132 as determined at the camera 140, the focal length F₁ of the first image relay lens 134, the groove spacing D_{g} of the grating 136, the focal length F₂ of the second image relay lens 138, the angle θ, and the offset D_{c}:

F₂ sin(θ)=D_{c} (1)

sin(θ)=λ/D_{g} (2)

D_{c}=F₂λ/D_{g} (3)

D_{sc}=DₛF₂/F₁ (4)

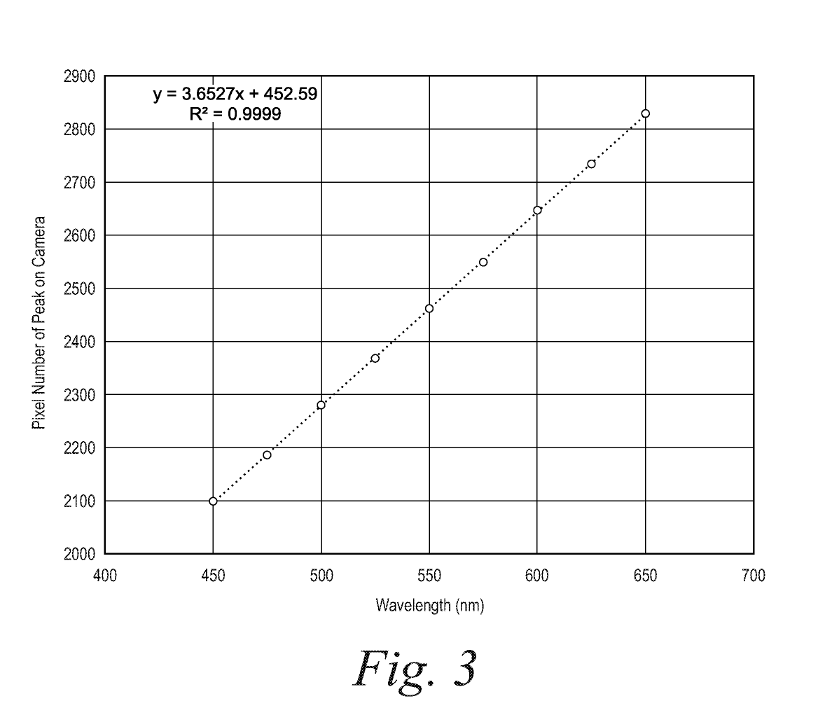

FIG. 3 illustrates a graph of the linear relationship between wavelength and the offset D_{c} as measured by pixel number from a zero order beam for fluorescence signals. Thus, each wavelength is given by the offset D_{c}.

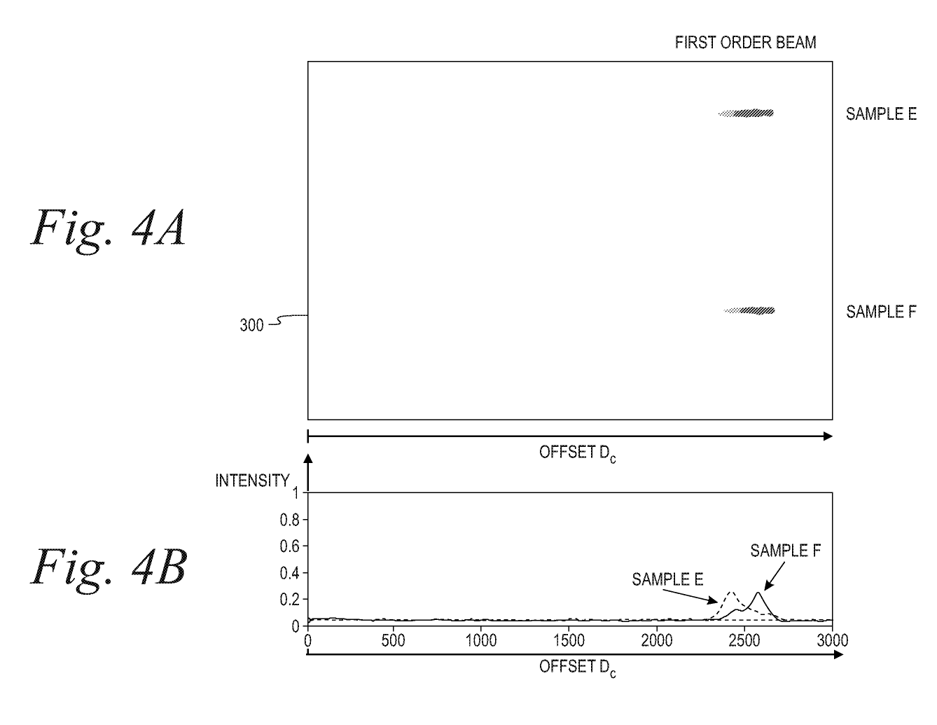

By measuring the intensity at each offset D_{c}, a wavelength intensity profile for each sample can be determined. For instance, FIG. 4A illustrates an example image 300 of first order beams for samples E and F with a measurement of the offset D_{c}. Correspondingly, FIG. 4B illustrates a graph of measurements of intensity at each offset D_{c} for each sample E, F in the image 300. The resulting graphs provide wavelength intensity profiles that can be employed to identify the samples E and F and/or characterize the properties of the samples E and F.

In the example of FIGS. 4A-B, a blue fluorophore may be associated with a first engineered protein that may appear in the samples, while a green fluorophore may be associated with a second engineered protein that may appear in the samples. As shown in FIG. 4A, the sample E corresponds with a blue variant associated with the first protein, and the sample F corresponds with a green variant associated with the second protein. FIGS. 4A-B shows that there may be an overlap in the fluorescent signal from the samples E and F. Despite the overlap, the samples E and F are readily distinguishable by the different shapes of their respective intensity profiles over a spectrum of multiple wavelengths.

Advantageously, embodiments of the system 100 allow a spectrum of wavelengths to be analyzed (multispectral analysis) to provide distinct wavelength intensity profiles and enhance identification and/or characterization of samples. As opposed to analysis based on the intensity provided by one or two wavelengths for instance, multispectral analysis allows more data to be extracted from the fluorescent signals. In the example of FIGS. 4A-B, multispectral analysis captures the nuances between the engineered proteins.

As shown further in FIG. 1, the camera 140 may be communicatively coupled to a controller 142 with one or more processors, which may be programmed according to instructions stored on computer-readable storage media to analyze and/or present images captured by the camera 140 (e.g., images 200 and 300). In particular, the controller 142 may determine the wavelength intensity profiles to identify and/or characterize samples based on their fluorescence signals in the captured images. The controller 142 may also control other aspects of the system 100.

As an example, micropore arrays contemplated herein can be manufactured by bundling millions or billions of cavities or pores, such as in the form of silica capillaries, and fusing them together through a thermal process. Such a fusing process may comprise the steps including but not limited to; i) heating a capillary single draw glass that is drawn under tension into a single clad fiber; ii) creating a capillary multi draw single capillary from the single draw glass by bundling, heating, and drawing; iii) creating a capillary multi-multi draw multi capillary from the multi draw single capillary by additional bundling, heating, and drawing; iv) creating a block assembly of drawn glass from the multi-multi draw multi capillary by stacking in a pressing block; v) creating a block pressing block from the block assembly by treating with heat and pressure; and vi) creating a block forming block by cutting the block pressing block at a precise length (e.g., 1 mm).

In one embodiment, the capillaries are cut to approximately 1 millimeter in height, thereby forming a plurality of micropores having an internal diameter between approximately 1.0 micrometers and 500 micrometers. In one embodiment, the micropores range between approximately 10 micrometers and 1 millimeter long. In one embodiment, the micropores range between approximately 10 micrometers and 1 centimeter long. In one embodiment, the micropores range between approximately 10 micrometers and 100 millimeters long. In one embodiment, the micropores range between approximately 0.5 millimeter and 1 centimeter long.

Very high-density micropore arrays may be used in the various aspects of the disclosure. In example embodiments, each micropore can have a 5 μm diameter and approximately 66% open space (i.e., representing the lumen of each cavity). In some arrays, the proportion of the array that is open ranges between about 50% and about 90%, for example about 60 to 75%, more particularly about 67%. In one example, a 10×10 cm array having 5 μm diameter cavities and approximately 66% open space has about 330 million micropores. The internal diameter of cavities may range between approximately 1.0 micrometers and 500 micrometers. In some arrays, each of the micropores can have an internal diameter in the range between approximately 1.0 micrometers and 300 micrometers; optionally between approximately 1.0 micrometers and 100 micrometers; further optionally between approximately 1.0 micrometers and 75 micrometers; still further optionally between approximately 1.0 micrometers and 50 micrometers, still further optionally, between approximately 5.0 micrometers and 50 micrometers.

In some arrays, the open area of the array comprises up to 90% of the open area (OA), so that, when the cavity size varies between 10 μm and 500 μm, the number of micropores per cm of the array varies between 458 and 1,146,500. In some arrays, the open area of the array comprises about 67% of the open area, so that, when the cavity size varies between 10 μm and 500 μm, the number of micropores per square cm of the array varies between 341 and 853,503. As an example, with a cavity size of 1 μm and up to 90% open area, each square cm of the array will accommodate up to approximately 11,466,000 micropores.

In one particular embodiment, a cavity array can be manufactured by bonding billions of silica capillaries and then fusing them together through a thermal process. After that slices (0.5 mm or more) are cut out to form a very high aspect ratio glass micro perforated array plate. A number of useful arrays are commercially available, such as from Hamamatsu Photonics K. K. (Japan), Incom, Inc. (Massachusetts), Photonis Technologies, S.A.S. (France) Inc. and others. In some embodiments, the cavities of the array are closed at one end with a solid substrate attached to the array.

In various aspects, the disclosure relate to screening a library of cells having a plurality of genotypes for a cell having a phenotype of interest, such a cell producing a protein or other molecule having a phenotype of interest. In general, the method is available for screening all cell types, e.g., mammalian, fungal, bacterial, and insect, that are able to survive and/or multiply in the array. Phenotypes of interest can include any biological process that renders a detectable result, including but not limited to production, secretion and/or display of polypeptides and nucleic acids. Libraries of cells having a plurality of genotypes associated with detectable phenotypes can be generated by methods involving error prone PCR, random activation of gene expression, phage display, overhang-based DNA block shuffling, random mutagenesis, in vitro DNA shuffling, site-specific recombination, and other methods generally known to those of skill in the art.

The array may be designed such that some or all cavities contain a single biological element to screen for the analyte. The concentration of the heterogeneous mixture of cells is therefore calculated according to the design of the array and desired analytes to identify. In embodiments where protein-producing cells are being screened, the method can eliminate clonal competition and screen a much larger diversity of cells.

The array may be loaded by contacting a solution containing a plurality of cells, such as a heterogeneous population of cells, with the array. In one embodiment, loading a mixture of antibody displaying or secreting cells, e.g., E. coli or yeast, evenly into all the cavities involves placing a 500 μL droplet on the upper side of the array and spreading it over all the micropores. As an example, an initial concentration of approximately 10⁹ cells in the 500 μL, droplet results in approximately 3 cells (or sub-population) per cavity. In one embodiment, each micropore has an approximate volume of between 20-80 pL (depending on the thickness of the glass capillary plate of between 250 μm to 1 mm). Once the cavities are loaded and incubated overnight, each cavity should then contain approximately 10 to 3,000 cells per cavity. In one embodiment, the cells may be cultivated for up to forty-eight hours or longer without loss of viability in order to maximize the proliferation yield. The plurality of cells may be animal cells, plant cells, and/or microbial cells, for example, bacterial or yeast cells. The cells may secrete or display at least one compound of interest, such as a recombinant compound of interest has an affinity for a binding partner.

In various examples, if there are approximately 10⁹ cells in an approximate 5000 μL solution then, on average, there should be approximately ten cells per micropore for an array having approximately 3-4×10⁶ micropores, assuming a cavity volume of 50 picoliters. The exact number will depend on the volume of the cavity in the array and the concentration of cells in solution. As an example, each micropore may have a volume of ranging between approximately 20-80 picoliters.

A sample containing the population and/or library of cells may require preparation steps prior to distribution to the array. In some embodiments, these preparation steps include an incubation time. The incubation time will depend on the design of the screen and the cells being screened. Example times include 5 minutes, 1 hour, 3 hours, 6 hours, 12 hours, 1 day, 2 days and 3 days or more. The heterogeneous population of cells may be expanded in media prior to adding and/or loading onto the array. For certain applications, the cell containing media may be loaded into the array while in the exponential growth phase. Each cavity may have a volume of media that will allow the cells to replicate. For example, 20 picoliter can provide sufficient media to allow most single cells within a cavity to replicate multiple times. The array can optionally be incubated at any temperature, humidity, and time for the cells to expand and produce the target proteins or other biological elements of interest. Incubation conditions can be determined based on experimental design as is routine in the art.

In one embodiment, the method of the disclosure contemplates the concentration of the suspension of heterogeneous population of cells and the dimensions of the array are arranged such that 1-1000 biological elements, optionally, 1-500 biological elements, further optionally, 1-100 biological elements, still further optionally 1-10 biological elements, still further optionally, 1-5 biological elements, are distributed into at least one of the cavities of the array.

The volume of the cell-containing volume loaded onto the array will depend on several variables, including for example the desired application, the concentration of the heterogeneous mixture, and/or the desired dilution of biological elements. In one specific embodiment, the desired volume on the array surface is about 1 microliter per square millimeter. The concentration conditions are determined such that the biological elements are distributed in any desired pattern or dilution. In a specific embodiment, the concentration conditions are set such that in most cavities of the array only single elements are present. This allows for the most precise screening of single elements.

In other embodiments, the sample containing the heterogeneous population and/or library of cells may require preparation steps, e.g., incubation, after addition to the array. In other embodiments, each cell within each cavity is expanded (cells grown, phages multiplied, proteins expressed and released, etc.) during an incubation period. This incubation period can allow the cells to express or display the phenotype of interest, or allow virus to replicate.

After the cells have been loaded into the array, additional molecules or particles can be added or removed from the array without disturbing the cells. For example, any biological reactive molecule or particle useful in the detection of the cells can be added. These additional molecules or particles can be added to the array by introducing liquid reagents comprising the molecules or particles to the top of the array, such as for example by adding drop-wise as described herein in relation to the addition of the cells.

In certain embodiments, particles may be included with one or more biological elements. The particles may be combined with one or more biological elements prior to introducing the combination into cavities of the array or the particles may be provided in the cavities before or after including one or more biological elements.

Once a cavity or cavities of interest are identified, the contents of the cavities can be extracted with the apparatus and methods described herein. The cavity contents can be further analyzed or expanded. Expanded cell populations from a cavity or cavities can be rescreened with the array according the methods herein. For instance, if the number of biological elements in a population exceeds the number of cavities in the array, the population can be screened with more than one element in each pore. The contents of the cavities that provide a positive signal can then be extracted to provide a subpopulation. The subpopulation can be screened immediately or, when the subpopulation is cells, it can be expanded. The screening process can be repeated until each cavity of the array contains only a single element. The screen can also be applied to detect and/or extract the cavity that indicates the desired analyte is therein. Following the selection of the cavity, other conventional techniques may be used to isolate the individual analyte of interest, such as techniques that provide for higher levels of protein production.

Extraction of Cavity Contents

Based on the optical information received from a detector associated with the array of cavities, target cavities with the desired properties are identified and their contents extracted for further characterizations and expansion. The disclosed methods maintain the integrity of the biological elements in the cavities. Therefore the methods disclosed herein provide for the display and independent recovery of a target population of biological elements from a population of up to billions of target biological elements. This is particularly advantageous for embodiments where cells are screened.

For example, the signals from each cavity are scanned to locate the binding events of interest. This identifies the cavities of interest. Individual cavities containing the desired clones can be extracted using a variety of methods. For all extraction techniques, the extracted cells or material can be expanded through culture or amplification reactions and identified for the recovery of the protein, nucleic acid or other biological element. As described above, multiple rounds of screening are also contemplated. Following each screening, one or more cavities of interest can be extracted as described herein. The contents of each cavity can then be screened again until the desired specificity is achieved. In certain embodiments, the desired specificity will be a single biological element per pore. In these embodiments, extraction may follow each round of the screening before the cavities include only a single element.

In one embodiment, the method includes isolating cells located in the cavities by pressure ejection. For example, a separated cavity array is covered with a plastic film. In one embodiment, the method further provides a laser capable of making a hole through the plastic film, thereby exposing the spatially addressed micropore. Subsequently, exposure to a pressure source (e.g., air pressure) expels the contents from the spatially addressed cavity. See WO2012/007537.

Another embodiment is directed to a method of extracting a solution including a biological element from a single cavity in a cavity array. In this embodiment, the cavity is associated with an electromagnetic radiation absorbent material so that the material is within the cavity or is coating or covering the cavity. Extraction occurs by focusing electromagnetic radiation at the cavity to generate an expansion of the sample or of the material or both or evaporation that expels at least part of the sample from the cavity. Additionally, the meniscus associated with the solution in the single cavity may be disrupted due to mechanical motion of the particles excited by the radiation. The electromagnetic radiation source may be the same or different than the source that excites a fluorescent label. The source may be capable of emitting multiple wavelengths of electromagnetic radiation in order to accommodate different absorption spectra of the materials and the labels.

In some embodiments, subjecting a selected cavity to focused electromagnetic radiation can cause an expansion of the electromagnetic radiation absorbent material, which expels sample contents onto a substrate for collecting the expelled contents.

In some embodiments the laser should have sufficient beam quality so that it can be focused to a spot size with a diameter roughly the same or smaller than the diameter of the pore. For instance, when the array material is capable of absorbing electromagnetic radiation, for instance when the array is manufactured or coated with an electromagnetic radiation absorbing material, the laser spot diameter may be smaller than the capillary diameter with the laser focused at the material-sample interface. In some embodiments, the material of the array itself, without any coating, such a darkened or blackened capillary array, can function as the electromagnetic radiation absorbent material. For example, as further described herein, array may be constructed of a lead glass that has been reduced in a hydrogen atmosphere. In various embodiments, the focus of the laser may be 90%, 80%, 70%, 60%, 50%, 40%, 30%, 20% 10%, 9%, 8%, 7%, 6%, 4%, 4%, 3%, 2% or 1% the diameter of the cavity.

In one aspect, the electromagnetic radiation is focused on the electromagnetic radiation absorbing material, resulting in linear absorption of the laser energy and cavitation of the liquid sample at the material/liquid interface. The electromagnetic radiation causes an intense localized heating of an electromagnetic radiation absorbing material of the array causing explosive vaporization and expansion of a thin layer of fluid in contact with the material without heating the remainder of the contents of the cavity. In most applications, directing of electromagnetic radiation to the material should avoid heating that liquid that is not in contact with the material at the focus of the radiation to avoid heating the liquid contents of the cavity and impacting the biological material in the cells. Accordingly, while a very thin layer of liquid in proximity the focus of the electromagnetic radiation is heated to cause the explosive evaporation and expansion of the liquid, the amount of energy necessary to disrupt the meniscus is not sufficient to cause a significant increase in temperature of the entire liquid contents. In one aspect the laser is focused on the material of a cavity of the array adjacent the meniscus itself, causing a disruption of the meniscus without heating the liquid contents of the cavity other than the heating associated with the vaporization of a small amount of liquid at the portion of the meniscus adjacent the laser focus.

In certain embodiments, extraction from cavities of the array is accomplished by excitation of one or more particles in the cavity, wherein excitation energy is focused on the particles. Accordingly, some embodiments employ energy absorbing particles in the cavities and an electromagnetic radiation source capable of discreetly delivering electromagnetic radiation to the particles in each cavity of the array. In certain embodiments energy is transferred to the particles with minimal or no increase in the temperature of the solution within the cavity. In certain aspects, a sequence of pulses repeatedly agitates magnetic beads in a cavity to disrupt a meniscus, which expels sample contents onto a substrate for collecting the expelled contents.

The electromagnetic radiation emission spectra from the electromagnetic radiation source must be such that there is at least a partial overlap in the absorption spectra of the electromagnetic radiation absorbent material associated with the cavity. In certain embodiments, individual cavities from a cavity array are extracted by a sequence of short laser pulses rather than a single large pulse. For example, a laser is pulsed at wavelengths of between about 300 and 650, more particularly about 349 nm, 405 nm, 450 nm, or 635 nm. The peak power of the laser may be between, for example, approximately 50 mW and 100 mW. Also, the pulse length of the laser may be from about 1 msec to about 100 msec. In certain embodiments, the total pulse energy of the laser is between about 10 μJ and about 10 mJ, for instance 10, 25, 50, 100, 500, 1000, 2500, 5000, 7500, or 10,000 μJ. In certain embodiments, the diameter of the focus spot of the laser beam waist is between about 1 and about 20 μm, for instance 1, 2, 3, 4, 5, 6, 7, 8, 9, 10, 11, 12, 13, 14, 15, 16, 17, 18, 19 or 20 μm. In a particular example embodiment, the laser is pulsed at 75 mW peak power, 1 msec pulse length, 10 msec pulse separation, 2 μm diameter beam, with a total of 10 pulses per extraction.

In some embodiments, cavities of interest are selected and then extracted by focusing a 349 nm solid state UV laser at 20-30% intensity power. In one example, the source is a frequency tripled, pulsed solid-state Nd:YAG or Nd:YVO4 laser source emitting about 1 microJoule to about 1 milliJoule pulses in about a 50 nanosecond pulse. In another example, the source is a diode-pumped Q-switched Nd:YLF Triton UV 349 nm laser (Spectra-Physics). For instance, the laser may have a with a total operation time of about 15-25 ms, delivering a train of 35-55 pulses at about 2-3 kHz, at a pulse width of about 8-18 nsec, with a beam diameter of about 4-6 μm, and total power output of 80-120 μJ. In one particular example, the laser may have a with a total operation time of about 15-20 ms, delivering a train of about 41-53 pulses at about 2.5 kHz, at a pulse width of about 10-15 nsec, with a beam diameter of about 5 μm, and total power output of 100 μJ. Both continuous wave lasers with a shutter and pulsed laser sources can be used in accordance with the disclosure.

In some embodiments, a diode laser may be used as an electromagnetic radiation source. In certain embodiments, the focus of diode laser has a beam waist diameter between about 1 μm and about 10 μm, for instance a 1, 2, 3, 4, 5, 6, 7, 8, 9 or 10 μm diameter. The diode laser may have a peak power of between about 20 mW and about 200 mW peak power, for instance about 20 mW, 40 mW, 60 mW, 80 mW, 100 mW, 110 mW, 120 mW, 130 mW, 140 mW, 150 mW, 160 mW, 170 mW, 180 mW, 190 mW or 200 mW peak power. The diode laser can be used at wavelengths of between about 300 and about 2000 nm, for instance about 405 nm, 450 nm, or 635 nm wavelength. In other embodiments, an infrared diode laser is used at about 800 nm, 980 nm, 1300 nm, 1550 nm, or 2000 nm wavelengths. Longer wavelengths are expected to have less photoxicity for any given sample.

In certain embodiments, a diode laser is pulsed at between about 2 to 20 pulses, for instance 2, 4, 6, 8, 10, 12, 14, 16, 18, and 20 pulses, with a pulse length of about 1 to 10 msec, for instance, 1, 2, 3, 4, 5, 6, 7, 8, 9, and 10 msec, and having a pulse separation of approximately 1 msec to 100 msec, for instance 10, 20, 30, 40, 50, 60, 70, 80, 90 and 100 msec. In an example embodiment, the diode laser is an Oclaro HL63133DG laser with a peak power of 170 mW operating at a wavelength of 635 nm. In another example embodiment, the diode laser is an Osram PL450B laser operating at 450 nm.

In other example embodiments, a diode laser or a Triton laser are focused to diameters of between 1 to 10 microns. The lasers emit a train of 10 to 50 pulses over a time period of 10 msec to 100 msec. Each individual pulse has a time duration of 1 msec (diode laser) or 10 nsec (Triton laser). The total pulse train energy is approximately 100 microJoules. The laser energy is absorbed within a volume in the microcapillary which is approximately a cylinder with a diameter roughly equal to the diameter of the laser beam waist and a height determined by the absorption length of the laser beam. If magnetic beads are in the capillary the laser pulse energy is absorbed by the beads, primarily heating the surface of the bead that is directly exposed to the laser. The liquid in immediate proximity to this surface is explosively vaporized which propels the beads within the capillary. The explosive motion of the beads along with vaporization of the nearby liquid disrupts the meniscus and empties the capillary. If the material of the array itself absorbs the light then the laser energy is deposited primarily in the portion of the capillary wall upon which the laser is incident. If sufficient laser energy is absorbed in this absorbing volume in a short enough time, then the heat will not have time to diffuse to the surrounding liquid. The liquid in the absorption volume will be explosively vaporized by the laser pulse, causing a rapid expansion of a portion of the sample, which disrupts the meniscus and empties the contents of the microcapillary, and heat diffusion to the surrounding liquid outside of the absorbing volume will be minimized.

In a particular example, an individual laser pulse has a duration of approximately 1 msec and the beam waste diameter is approximately 10 microns. In this example, the single laser pulse will heat the volume of liquid within the absorption region of the laser beam and during the pulse the heat will diffuse only a few microns outside of the absorbing region. The energy deposited during the laser pulse causes the temperature of the liquid in the absorbing region to rise abruptly to many times the vaporization temperature. The liquid is explosively vaporized in this absorption region while the surrounding region stays essentially at its original temperature. The explosive vaporization of liquid within the absorbing region disrupts the meniscus and the liquid is expelled from the microcapillary with negligible heat diffusion from the absorbent material to the surrounding medium and resulting in negligible or no heating of the total liquid contents of the microcapillary.

The equation describing the distance of propagation of heat within a substance over a short time scale is:

(d=\sqrt{(α*τ)}).

Where d is the characteristic thermal diffusion distance, a is the thermal diffusion coefficient, and τ is the energy deposition time or laser pulse length. For water α=0.143 mm²/sec and with τ=1 msec this equation results in a predicted diffusion length of about 10 microns. A total pulse energy of 100 microJoules deposited in the approximate absorption cylinder volume determine by a beam with a waist diameter of 10 microns and a height of 10 microns (˜10e-12 cm³) will raise the temperature of the liquid in this volume to many, many times the evaporation temperature of the liquid, resulting in explosive expansion of liquid in this volume.

The Veritas laser supplies a train of about 40, 5 nsec pulses, each pulse separated by about 500 microseconds. Each pulse causes explosive expansion of the liquid in the absorbing volume, propelling the beads (if present) and disrupting the meniscus. The diode laser similarly delivers a train of ten 1 msec pulses separated by several milliseconds, which interacts with liquid in the capillary in a similar fashion. In both cases using multiple pulses in a pulse train enhances the extraction efficiency compared to using a single high energy pulse.

When microspheres used, the equation for the thermal relaxation time (tᵣ) for uniform spheres of diameter d is

$${t}_{r} = \frac{{d}^{2}}{27 k} = \frac{{( 1 μ m )}^{2}}{27 * .143 \times {10}^{- 6} \frac{{m}^{2}}{s}} = 259 ns$$

As long as the laser pulse is <˜300 ns (this changes depending on the diameter of the beads), there will be thermal confinement and rapid localized heating of the absorbent material.

In further example embodiments, the following parameters may be used

1) Laser parameters
a. Veritas laser
   i. Triton UV 349 nm laser (diode-pumped Q-switched Nd:YLF laser, Spectra-Physics)
   ii. Total operation time: 18±2 ms (n=5 measurements), delivering a train of 46.6±5.9 pulses at 2.5 kHz
   iii. Pulse width: 10-15 nsec
   iv. Beam diameter: 5 μm
   v. Total power: 100 μJ

2) Absorbing material
a. Superparamagnetic iron oxide-doped microbeads
   i. Diameter ˜1 um (can range from 100 nm-10 um)

$$Thermal relaxation time \text{:} {t}_{r} = \frac{{d}^{2}}{27 k} = \frac{{( 1 μ m )}^{2}}{27 * .143 \times {10}^{- 6} \frac{{m}^{2}}{s}} = 259 ns$$

b. Black capillary walls (e.g., lead-silicate layer from reducing alkaline-doped silicate glass in a hydrogen atmosphere).

Materials within the cavity can be, for example, the particles used in the binding assays as described above. Accordingly, the particles may have a property that allows the particles to respond to a force in order to accumulate at a surface, and also include an electromagnetic radiation absorbent material, e.g., DYNABEAD® particles. In various embodiments, energy is applied to the particles while they are accumulated at the surface after the signal at the surface is detected (by continued or reapplication of a force), or the force is removed so that the particles return to the sample solution. Alternatively, the cavities include particles or other materials that do not participate in the binding reactions but are to provide extraction of the contents as described herein. These particles may be functionalized so that they bind to the walls of the cavities independent of the binding reaction of the assay. Similar materials can be used to coat or cover the cavities, and in particular, high expansion materials, such as EXPANCEL® coatings (AkzoNobel, Sweden). In another embodiment the EXPANCEL® material can be supplied in the form of an adhesive layer that is bonded to one side of the array so that each cavity is bonded to an expansion layer.

Focusing electromagnetic radiation at a cavity can cause the electromagnetic radiation absorbing material to expand, which causes at least part of the liquid volume of the cavity to be expelled. When the material is heated to cause rapid expansion of the cavity content, a portion of the of the contents may be expanded up to, for example, 1600 times, which causes a portion of the remainder of the contents to be expelled from the cavity.

Without rapid expansion of the material or cavity contents, heating can cause evaporation of the contents, which can be collected by condensing the contents on a substrate. For example, the substrate can be a hydrophobic micropillar placed at or near the opening of the cavity. Expulsion of the contents may also occur as the sample evaporates and condenses on the walls of a capillary outside the meniscus, which causes the meniscus to break and release the contents of the capillary.

Cavities can be open at both ends, with the contents being held in place by hydrostatic force. During the extraction process, one of the ends of the cavities can be covered to prevent expulsion of the contents from the wrong end of the cavity. The cavities can be covered in the same way as, for example, the plastic film or polymer gel coatings described above. Also, the expansion material may be bonded as a layer to one side of the array.

In one embodiment, the electromagnetic radiation source of the apparatus is broad spectrum light or a monochromatic light source having a wavelength that matches the wavelength of at least one label in a sample. In a further embodiment, the electromagnetic radiation source is a laser, such as a continuous wave laser. In yet a further embodiment, the electromagnetic source is a solid state UV laser. A non-limiting list of other suitable electromagnetic radiation sources include: argon lasers, krypton, helium-neon, helium-cadmium types, and diode lasers. In some embodiments, the electromagnetic source is one or more continuous wave lasers, arc lamps, or LEDs.

In some embodiments, the apparatus comprises multiple (one or more) electromagnetic sources. In other embodiments, the multiple electromagnetic (EM) radiation sources emit electromagnetic radiation at the same wavelengths. In other embodiments, the multiple electromagnetic sources emit different wavelengths in order to accommodate the different absorption spectra of the various labels that may be in the sample.

In some embodiments, the multiple electromagnetic radiation sources comprise a Triton UV laser (diode-pumped Q-switched Nd:YLF laser, Spectra-Physics) operating at a wavelength of 349 nm, a focused beam diameter of 5 μm, and a pulse duration of 20 ns. In still further embodiments, the multiple electromagnetic radiation sources comprise an X-cite 120 illumination system (EXFO Photonic Solutions Inc.) with a XF410 QMAX FITC and a XF406 QMAX red filter set (Omega Optical). In an example embodiment, a diode laser is a Oclaro HL63133DG laser with a peak power of 170 mW operating at a wavelength of 635 nm. In another example embodiments, the diode laser is an Osram PL450B laser operating at 450 nm.

The apparatus also includes a detector that receives electromagnetic (EM) radiation from the label(s) in the sample, array. The detectors can identify at least one cavity (e.g., a cavity) emitting electromagnetic radiation from one or more labels.

In one embodiment, light (e.g., light in the ultra-violet, visible or infrared range) emitted by a fluorescent label after exposure to electromagnetic radiation is detected. The detector or detectors are capable of capturing the amplitude and duration of photon bursts from a fluorescent moiety, and further converting the amplitude and duration of the photon burst to electrical signals. In some embodiments the detector or detectors are inverted.

Once a particle or element is labeled to render it detectable, or if the particle possesses an intrinsic characteristic rendering it detectable, any suitable detection mechanism known in the art may be used without departing from the scope of the disclosure, for example a CCD camera, a video input module camera, a Streak camera, a bolometer, a photodiode, a photodiode array, avalanche photodiodes, and photomultipliers producing sequential signals, and combinations thereof. Different characteristics of the electromagnetic radiation may be detected including: emission wavelength, emission intensity, burst size, burst duration, fluorescence polarization, and any combination thereof. As one example, a detector compatible with the disclosure is an inverted fluorescence microscope with a 20× Plan Fluorite objective (numerical aperture: 0.45, CFI, WD: 7.4, Nikon) and an ORCA-ER cooled CCD camera (Hamamatsu).

The detection process can also be automated, wherein the apparatus comprises an automated detector, such as a laser scanning microscope.

In some embodiments, the apparatus as disclosed can comprise at least one detector; in other embodiments, the apparatus can comprise at least two detectors, and each detector can be chosen and configured to detect light energy at the specific wavelength range emitted by a label. For example, two separate detectors can be used to detect particles that have been tagged with different labels, which upon excitation with an electromagnetic source, will emit photons with energy in different spectra.

Evaporation from the cavities of a cavity array complicates the measurement of the contents of the cavity by changing the height of the meniscus in the cavity. In particular, mass transfer due to evaporation of the liquid in the cavity occurs between the cavity and any surface nearby if that surface is at a lower temperature. This evaporation changes the height of the meniscus in the cavity which raises the position of the cells in the cavity and can make laser extraction more difficult and also can raise the signal producing element (e.g., cell, beads) out of the focal plane of the microscope.

In some embodiments, the number of cells in the sample liquid results in a diverse population of cells in each cavity. Following extraction and expansion of the contents of a particular cavity, the resulting population can be screened in subsequent steps to identify particular cells of interest. FIGS. 5 and 6 show before and after fluorescence and Brightfield images of an example array before and after extraction of a cavity of the array. White arrows indicate the same cavities pre- and post-extraction.

As shown in FIG. 6, extraction of the cavity resulted in two cells of interest from a single cavity. In other embodiments, the number of cells in a sample liquid is less than the number of cavities in the array, resulting in the loading only one cell or less in each of the cavities. Accordingly, from the content of the cavity extracted in an initial screening with more than one cell per cavity, subsequent screening of the contents of the cavity following expansion of the contents of the cavity and loading at a low concentration on an array can identify single cells having a phenotype of interest from a large diverse population of cells.

In addition, the library may be enriched by (1) extracting DNA from the cells comprising a gene for the phenotype of interest, (2) amplifying the DNA under conditions to introduce random mutations in the gene; (3) creating a second generation library of cells comprising the amplified DNA, and (4) repeating steps identified above with the second generation library. During an initial screen of the library or in the enrichment process, multiple cells may be added to any particular cavity. Cell contents may be extracted and further analyzed or enriched in accordance with the method of the disclosure. Ultimately, having one cell per cavity allows for identification of a particular genotype. The extracting may discreetly directing electromagnetic radiation to the cavities having cells producing proteins having a phenotype of interest, wherein the directing of electromagnetic radiation to the cavities does not heat the liquid prior to extraction.

In various aspects of the method, the phenotype of interest is a cell surface binding agent. In another aspect, the phenotype of interest is a fluorescent protein that has at least one of an absorption or emission intensity of interest, an absorption or emission spectra of interest, and a stokes shift of interest. Moreover, the phenotype of interest may be the production of a protein having enzymatic activity, a protein having a lack of inhibition of enzyme activity, and a protein having activity in the presence of an inhibitor for the enzyme.

Certain embodiments of the disclosure provide methods and apparatus for growth of one or more biological elements. In some embodiments, a cell is introduced into a cavity of an array in a culture medium suitable for growth. The array is then incubated under conditions that support growth of the cells, for example at suitable temperature, humidity, and atmospheric gas composition. In some embodiments, the surfaces of the cavity array are treated to support growth of cells added to the array.

Particles

In various embodiments, the cavities of the arrays are loaded with particles as solid surfaces supporting binding reactions and/or as energy absorbing material that facilitates extracting of cavity contents. Suitable particles are readily commercially available and a wide variety of particles can be used according to the methods disclosed herein. In various embodiments, the particles are partially or fully opaque. In certain embodiments, the particles absorb electromagnetic radiation, for example the particles have an efficiency of absorbance of at least about 10 percent, for example, 25, 30, 35, 40, 45, 50, 55, 60, 65, 70, 75, 80, 85, 90, 95 or 100 percent.

In various embodiments, the size of the particles ranges from nanoscale to about one-third the size of the cross section of a cavity. For example, when a cavity is about 20 microns in diameter, the particle can be about 0.01 to 7 microns in diameter. In other embodiments, the particle diameter ranges from about 0.01 microns to about 50 microns, depending on the size of the cavity used. In various embodiments, the particles range in size from about 0.1 to 15 microns, about 0.5 to 10 microns, and about 1 to about 5 microns. In certain embodiments, the particles comprise a metal or carbon. Non-limiting examples of suitable metals include gold, silver, and copper. Other metallic materials are suitable for use in binding and detection assays as is well known to those of skill in the art.

In one embodiment, the particles are magnetic such that magnetic force can be used to accumulate the particles at a surface of each reaction cavity, e.g., the meniscus of a cavity as describe in US patent publication No. 2014/011690, which is incorporated by reference herein in its entirety.

In some aspects of the disclosure, the surface chemistry of the particles may be functionalized to provide for binding to sample components as is well known to those of skill in the art. For example, the particles are coupled with streptavidin, biotin, oligo(dT), protein A & G, tagged proteins, and/or any other linker polypeptides. The very high binding affinity of the streptavidin-biotin interaction is utilized in a vast number of applications. Streptavidin coated particles will bind biotinylated nucleic acids, antibodies or other biotinylated ligands and targets. Biotinylated antigens are also a useful example of reagents that could be attached to the particles for screening for analytes. In a specific embodiment, the particles are DYANABEAD® particles (Invitrogen, Carlsbad, Calif.) coupled to several different ligands. For example, oligo(dT), protein A & G, tagged proteins (His, FLAG), secondary antibodies, and/or streptavidin. (Part No. 112-05D, Invitrogen, Carlsbad, Calif.).

In some embodiments, particles having different magnetic permittivities can be used to provide independent control of the magnetic forces acting on the particles. In other embodiments, other properties of the particles can be used to expand the multiplexing capability of the assays done in each cavity. When added to a sample, particles bind to the desired target (cells, pathogenic microorganisms, nucleic acids, peptide, protein or protein complex etc). This interaction relies on the specific affinity of the ligand on the surface of the particles. Alternatively, the particles conjugated to substrate for an enzyme can be added to the sample, where the enzyme/analyte in the sample either quenches the ability of the substrate to fluoresce or activates the substrate to be fluorescent (e.g., enzyme mediated cleavage of the substrate).

Another embodiment uses magnetic particles having different shapes, densities, sizes, charges, magnetic permittivity, or optical coatings. This allows different probes (i.e., binding partners) to be put on the different particles and the particles could be probed separately by adjusting how and when the magnetic field or other force is applied. Sedimentation rates can also be used to separate the particles by size, shape and density and expand the multiplexing capability of the assays done in each cavity. In an example embodiment, the particles comprise superparamagnetic iron oxide-doped microbeads with an average diameter of about 1 μm, for instance about 100 nm to about 10 μm.

In certain embodiments, the particles are used to mix the content of the cavities. For example, magnetic particles are subjected to and alternating or intermittent magnetic field(s) during an incubation step. The movement and settling of the particles results in the mixing of the contents of the reaction cavity.

Any suitable binding partner with the requisite specificity for the form of molecule, e.g., a marker, to be detected can be used. If the molecule, e.g., a marker, has several different forms, various specificities of binding partners are possible. Suitable binding partners are known in the art and include antibodies, aptamers, lectins, and receptors. A useful and versatile type of binding partner is an antibody.

The method for detecting an analyte in a sample disclosed herein allows for the simultaneous testing of two or more different antigens per pore. Therefore, in some embodiments, simultaneous positive and negative screening can occur in the same pore. This screening design improves the selectivity of the initial hits. In certain embodiments, the second antigen tested can be a control antigen. Use of a control antigen is useful for normalizing biological element concentration across the various cavities in the array. A non-limiting example would be using a first antigen specific for an analyte of interest, and a second antigen that is non-specific for all proteins, such as an N- or C-terminal epitope tag. Therefore the results of cavities of interest can be quantified by comparing the signal to total protein concentration.

In some embodiments, the second antigen is associated with second particles that are different from the first particles. The particles can vary by least one of the following properties: shape, size, density, magnetic permittivity, charge, and optical coating. The second label can therefore associate with the second particles as a result of the presence or absence of a second analyte in the sample, and processed using motive forces as described below.

In another embodiment, the particles non-specifically bind sample components. For example, particles can be functionalized to non-specifically bind all protein in a sample, which allows for normalization of protein content between samples in an array.

Antibodies

The term “antibody,” as used herein, is a broad term and is used in its ordinary sense, including, without limitation, to refer to naturally occurring antibodies as well as non-naturally occurring antibodies, including, for example, single chain antibodies, chimeric, bifunctional and humanized antibodies, as well as antigen-binding fragments thereof. It will be appreciated that the choice of epitope or region of the molecule to which the antibody is raised will determine its specificity, e.g., for various forms of the molecule, if present, or for total (e.g., all, or substantially all, of the molecule).

Methods for producing antibodies are well-established. One skilled in the art will recognize that many procedures are available for the production of antibodies, for example, as described in Antibodies, A Laboratory Manual, Ed Harlow and David Lane, Cold Spring Harbor Laboratory (1988), Cold Spring Harbor, N.Y. One skilled in the art will also appreciate that binding fragments or Fab fragments that mimic antibodies can be prepared from genetic information by various procedures (Antibody Engineering: A Practical Approach (Borrebaeck, C., ed.), 1995, Oxford University Press, Oxford; J. Immunol. 149, 3914-3920 (1992)). Monoclonal and polyclonal antibodies to molecules, e.g., proteins, and markers also commercially available (R and D Systems, Minneapolis, Minn.; HyTest Ltd., Turk, Finland; Abcam Inc., Cambridge, Mass., USA, Life Diagnostics, Inc., West Chester, Pa., USA; Fitzgerald Industries International, Inc., Concord, Mass., USA; BiosPacific, Emeryville, Calif.).

In some embodiments, the antibody is a polyclonal antibody. In other embodiments, the antibody is a monoclonal antibody.

Capture binding partners and detection binding partner pairs, e.g., capture and detection antibody pairs, can be used in embodiments of the disclosure. Thus, in some embodiments, a heterogeneous assay protocol is used in which, typically, two binding partners, e.g., two antibodies, are used. One binding partner is a capture partner, usually immobilized on a particle, and the other binding partner is a detection binding partner, typically with a detectable label attached. Such antibody pairs are available from several commercial sources, such as BiosPacific, Emeryville, Calif. Antibody pairs can also be designed and prepared by methods well-known in the art. In a particular embodiment, the antibody is biotinylated or biotin labelled

In one embodiment, there is a second imaging component that binds all members of the analyte of interest non-specifically. Therefore this signal can be read to normalize the quantity of fluorescence from cavity to pore. One example is an antibody that will bind all proteins at an N- or C-terminal epitope tag.

Labels

Several strategies that can be used for labeling binding partners to enable their detection or discrimination in a mixture of particles are well known in the art. The labels may be attached by any known means, including methods that utilize non-specific or specific interactions. In addition, labeling can be accomplished directly or through binding partners.

Emission, e.g., fluorescence, from the moiety should be sufficient to allow detection using the detectors as described herein. Generally, the compositions and methods of the disclosure utilize highly fluorescent moieties, e.g., a moiety capable of emitting electromagnetic radiation when stimulated by an electromagnetic radiation source at the excitation wavelength of the moiety. Several moieties are suitable for the compositions and methods of the disclosure.

Labels activatable by energy other than electromagnetic radiation are also useful in the disclosure. Such labels can be activated by, for example, electricity, heat or chemical reaction (e.g., chemiluminescent labels). Also, a number of enzymatically activated labels are well known to those in the art.

Typically, the fluorescence of the moiety involves a combination of quantum efficiency and lack of photobleaching sufficient that the moiety is detectable above background levels in the disclosed detectors, with the consistency necessary for the desired limit of detection, accuracy, and precision of the assay.

Furthermore, the moiety has properties that are consistent with its use in the assay of choice. In some embodiments, the assay is an immunoassay, where the fluorescent moiety is attached to an antibody; the moiety must have properties such that it does not aggregate with other antibodies or proteins, or experiences no more aggregation than is consistent with the required accuracy and precision of the assay. In some embodiments, fluorescent moieties dye molecules that have a combination of 1) high absorption coefficient; 2) high quantum yield; 3) high photostability (low photobleaching); and 4) compatibility with labeling the molecule of interest (e.g., protein) so that it may be analyzed using the analyzers and systems of the disclosure (e.g., does not cause precipitation of the protein of interest, or precipitation of a protein to which the moiety has been attached).

A fluorescent moiety may comprise a single entity (a Quantum Dot or fluorescent molecule) or a plurality of entities (e.g., a plurality of fluorescent molecules). It will be appreciated that when “moiety,” as that term is used herein, refers to a group of fluorescent entities, e.g., a plurality of fluorescent dye molecules, each individual entity may be attached to the binding partner separately or the entities may be attached together, as long as the entities as a group provide sufficient fluorescence to be detected.

In some embodiments, the fluorescent dye molecules comprise at least one substituted indolium ring system in which the substituent on the 3-carbon of the indolium ring contains a chemically reactive group or a conjugated substance. Examples include Alexa Fluor molecules.

In some embodiments, the labels comprise a first type and a second type of label, such as two different ALEXA FLUOR® dyes (Invitrogen), where the first type and second type of dye molecules have different emission spectra.

A non-inclusive list of useful fluorescent entities for use in the fluorescent moieties includes: ALEXA FLUOR® 488, ALEXA FLUOR® 532, ALEXA FLUOR® 555, ALEXA FLUOR® 647, ALEXA FLUOR® 700, ALEXA FLUOR® 750, Fluorescein, B-phycoerythrin, allophycocyanin, PBXL-3, Atto 590 and Qdot 605.

Labels may be attached to the particles or binding partners by any method known in the art, including, absorption, covalent binding, biotin/streptavidin or other binding pairs. In addition, the label may be attached through a linker. In some embodiments, the label is cleaved by the analyte, thereby releasing the label from the particle. Alternatively, the analyte may prevent cleavage of the linker.

FRET Biosensor Engineering

Addressing an unmet need in high-throughput biology, embodiments of the system 100 provide a user-friendly, cost-effective technology that can rapidly interrogate the sequence-structure-activity relationship of millions of protein variants, with functional read-outs that span a range of biophysical and biochemical measurements. In particular, the capabilities and breadth of the technology can be showcased through discovery applications using fluorescent protein biosensors.

In general terms, a biosensor may be defined as a detection platform that utilizes biological recognition and a physical transducer to couple a recognition event to an assayable signal output. Since biomolecular recognition regulates physiological behavior at the level of the cell, the concept of biosensing lends itself to use by biochemically and biologically minded researchers. The sensitivity of fluorescence and its ability to be genetically encoded make fluorescent proteins (or FPs) ideal for designing biosensors. Several biosensing platforms or strategies exist to assay physiological processes in real time. These strategies fall into four general classes: resonance energy transfer (RET) biosensors, complementation based biosensors, dimerization-dependent FP-based biosensors, and single FP-based biosensors.

The design and engineering of fluorescent protein (FP)-based FRET biosensors is restricted to low-throughput methods and empirical optimization. Using molecular biology, diverse biosensor gene libraries can be easily designed/created, but cannot be adequately evaluated due to a lack of high throughput screening technology. Therefore, a vast molecular space goes unexplored during efforts to enhance the dynamic range and sensitivity of biosensors, and often results in abandoned biosensor development based on the failure of a just a handful of designs. The current standard for biosensor evaluation is empirical testing in transfected mammalian cells or in microtiter plates (at best). Further, engineering biosensors in bacteria is almost always incompatible with the desired analyte or process occurring in eukaryotic/mammalian cells.

By providing rapid and high-throughput screening of variants and isolation of variants with desirable properties, embodiments of the example system 100 provide a leap forward in FP-based biosensor development and allow new biosensors to be discovered and optimized by directed evolution. For instance, peptide linker composition and length, as well as sensing (FPs) and output domain orientations and composition, can be genetically altered and analyzed to identify the most robust biosensors for a given analyte or process.

The advantages of the example system 100 also apply to the development of biosensors based on 1) fluorescent protein complementation (or Bimolecular Fluorescence Complementation) and 2) dimerization-dependent fluorescence proteins, 3) single-FP based biosensors, and 4) bioluminescent resonance energy transfer. Furthermore, the biosensors may be developed to monitor changes in analyte concentrations (e.g., small ions, sugars, hormones), pH, enzymatic reactions, post-translational modifications, cellular localization, small molecule agonists/antagonists, proteases, electrical potential, biomolecule proximity (e.g., protein-protein interactions, protein-DNA interactions, protein-lipid interactions, etc)

FRET-Based Protein-Protein Interactions

FRET is employed to identify protein-protein interaction partners in live cells. Embodiments of the system 100 allow screening of protein libraries (akin to yeast-two hybrid assays) to identify protein-protein interactions based on proximity-induced changes in FRET efficiency between a donor FP (e.g., CFP) and an acceptor FP (e.g., YFP). In a related application, embodiments may be used to identify small peptide inhibitors of known protein-protein interactions, which may have therapeutic applications. These kinds of screens can be performed in yeast, or ultimately mammalian cells.

Fluorescent Biosensor Reporter Cell Line Development

Stable reporter cell lines are an invaluable resource for the discovery of biological modulators (e.g. agonists and antagonists). Initial steps to generate reporter cell lines often result in heterogenous populations of cells, expressing different levels of biosensor components or no components at all. Advantageously, embodiments of the system 100 can rapidly identify the reporter cells exhibiting robust responses to target analytes/processes. Embodiments enable rapid identification and isolation of those cells exhibiting the best reporter outputs (e.g., ratiometric changes in FRET efficiency).

Although preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein can be employed in practicing the disclosure. It is intended that the following claims define the scope of the disclosure and that methods and structures within the scope of these claims and their equivalents be covered thereby.

What is claimed is:

1. A system for analyzing one or more samples disposed in cavities of an array, comprising:
an excitation light source configured to emit an excitation light having one or more excitation wavelengths that cause one or more samples disposed in respective cavities of an array to fluoresce;
a cylinder lens configured to transmit the excitation light from the excitation light source as an astigmatic beam;
a microscope objective configured to receive the astigmatic beam from the cylinder lens and to focus the excitation light as a line onto a column of cavities of the array, one or more samples disposed in the column of cavities simultaneously emitting a respective fluorescence signal in response to the line of excitation light, the microscope objective being further configured to transmit each respective fluorescence signal simultaneously;
a grating configured to receive each respective fluorescence signal simultaneously and cause each respective fluorescence signal from the microscope objective to diffract, the diffraction producing a zero order beam and a first order beam for each respective fluorescence signal;
an image relay lens configured to receive the zero order beam and the first order beam for each respective fluorescence signal from the grating; and
a camera configured to capture an image of the zero order beam and the first order beam from the image relay lens for each respective fluorescence signal, the image relay lens causing the first order beam to be spatially separated from the zero order beam on the image, the image indicating an intensity profile based on the spatial separation between the first order beam and the zero order beam, the intensity profile identifying the at least one sample.

2. The system of claim 1, wherein each respective fluorescence signal has one or more fluorescence wavelengths, the first order beam for each respective fluorescence signal is determined by each fluorescence wavelength in the respective fluorescence signal, the image relay lens causes, for each respective fluorescence signal, the first order beam to be spatially separated from the zero order beam on the image according to an offset for each fluorescence wavelength in the respective fluorescence signal, and the image indicates an intensity profile based on an intensity at each offset.

3. The system of claim 1, further comprising:
a tube lens configured to transmit each respective fluorescence signal from the microscope objective;
a slit configured to receive each respective fluorescence signal focused from the tube lens and to transmit each respective fluorescence signal simultaneously in a line image; and
an additional image relay lens configured to collimate each respective fluorescence signal simultaneously,
wherein the grating receives each respective fluorescence signal simultaneously from the additional image relay lens.

4. The system of claim 1, further comprising a filter configured to filter each respective fluorescence signal from the microscope objective.

5. The system of claim 1, further comprising a beamsplitter configured to direct the excitation light from the cylinder lens to the microscope objective and to direct each respective fluorescence signal from the microscope objective to the grating.

6. The system of claim 1, wherein each respective fluorescence signal includes a plurality of fluorescence wavelengths and the image indicates an intensity profile based on a plurality of intensities across a spectrum of the plurality of fluorescence wavelengths.

7. The system of claim 1, further comprising an electromagnetic radiation source configured to emit electromagnetic radiation for extracting a selected sample from a selected cavity in the array.

8. The system of claim 7, wherein the electromagnetic radiation source includes an extraction laser for extracting the selected sample from the selected cavity in the array, and the microscope objective focuses the extraction laser onto the selected cavity.

9. The system of claim 8, further comprising a beamsplitter configured to direct the astigmatic beam for the excitation light and the extraction laser along a common path to the microscope objective.

10. The system of claim 9, further comprising an image relay telescope configured to transfer an image of an entrance pupil of the microscope objective to a plane near the beamsplitter to align the excitation light and the extraction laser with respect to the microscope objective.

11. The system of claim 1, further comprising an electromechanical device configured to produce relative movement between the array relative and the microscope objective, the relative movement allowing the microscope objective to focus the line of excitation light on additional columns of the array and to receive and transmit fluorescence signals from samples in the additional columns.

12. A system for analyzing one or more samples disposed in cavities of an array, comprising:
an excitation light source configured to emit an excitation light having one or more excitation wavelengths that cause one or more samples disposed in respective cavities of an array to fluoresce;
one or more optical elements configured to receive and focus the excitation light onto cavities of the array;
a grating configured to receive a respective fluorescence signal emitted from each of the one or more samples in response to the excitation light, and to cause each respective fluorescence signal to diffract, the diffraction producing a zero order beam and a first order beam for each respective fluorescence signal;
an image relay lens configured to receive the zero order beam and the first order beam for each respective fluorescence signal from the grating; and
a camera configured to capture an image of the zero order beam and the first order beam from the image relay lens for each respective fluorescence signal, the image relay lens causing the first order beam to be spatially separated from the zero order beam on the image, the image indicating an intensity profile based on a plurality of intensities across a spectrum of a plurality of fluorescence wavelengths based on the spatial separation between the first order beam and the zero order beam, the intensity profile identifying the at least one sample.

13. The system of claim 12, wherein each respective fluorescence signal has the plurality of fluorescence wavelengths, the first order beam for each respective fluorescence signal is determined by each fluorescence wavelength in the respective fluorescence signal, the image relay lens causes, for each respective fluorescence signal, the first order beam to be spatially separated from the zero order beam on the image according to an offset for each fluorescence wavelength in the respective fluorescence signal, and the image indicates the intensity profile based on an intensity at each offset.

14. The system of claim 12, wherein the one or more optical elements include a microscope objective configured to focus the excitation light onto the cavities of the array and to transmit each respective fluorescence signal simultaneously to the grating.

15. The system of claim 14, wherein the one or more optical elements further include:
a tube lens configured to transmit each respective fluorescence signal from the microscope objective;
a slit configured to receive each respective fluorescence signal focused from the tube lens and to transmit each respective fluorescence signal simultaneously in a line image; and
an additional image relay lens configured to collimate each respective fluorescence signal simultaneously,
wherein the grating receives the each respective fluorescence signal simultaneously from the additional image relay lens.

16. The system of claim 12, further comprising a beamsplitter configured to direct the excitation light to the array and to direct each respective fluorescence signal from the array to the grating.

17. The system of claim 12, further comprising an electromagnetic radiation source configured to emit electromagnetic radiation for extracting a selected sample from a selected cavity in the array.

18. The system of claim 17, wherein the electromagnetic radiation source includes an extraction laser for extracting the selected sample from the selected cavity in the array.

19. The system of claim 18, further comprising a beamsplitter configured to receive and direct the excitation light and the extraction laser along a common path to the array.

20. The system of claim 12, wherein the one or more optical elements are further configured to scan the excitation light over the cavities of the array.
